(19) United States
(12) Patent Application Publication
(10) Pub. No.: US 2026/0219937 A1
(43) Pub. Date: Jul. 30, 2026

(54) MANAGEMENT OF COMPUTE RESOURCES FOR CONTAINERS

(71) Applicant: International Business Machines Corporation, Armonk, NY (US)

(72) Inventors: Zhan Peng Huo, Beijing (CN); Yu Zui You, Ningbo (CN); Xiao Ling Chen, Changping District (CN); Heng Wang, Changping District (CN)

(21) Appl. No.: 19/040,894

(22) Filed: Jan. 30, 2025

(51) Int. Cl. G06F 9/50

(52) U.S. Cl. CPC G06F 9/5027

(57) ABSTRACT

Management of compute resources for containers includes obtaining first usage data associated with at least one container and obtaining a set of threshold parameters. A system compares the first usage data with the set of threshold parameters. The system detects a first anomaly associated with a usage of the one or more compute resources by the at least one container. The system also determines a first set of allocation parameters associated with the at least one container. The system also generates a first allocation command for allocating the one or more compute resources to the at least one container.

### BACKGROUND

The disclosure relates to compute resources’ management and more particularly, to the management of compute resources.

In modern application development, containerization technology is used by developers to package applications and their dependencies into standardized units called containers. Each container includes multiple data layers, with each data layer representing a distinct set of modifications or additions to an underlying file system. This layered architecture allows efficient storage and transfer, enabling swift deployment and scaling of the applications across multiple environments.

Further, container images serve as building blocks of containerization, encapsulating not only the application code but also libraries, dependencies, and configuration files for running an application seamlessly across different environments. This self-contained nature of the container images ensures that the applications can be executed consistently, regardless of the underlying infrastructure. The use of a layered file system within the container images enables incremental updates, allowing the developers to modify only data layers that have changed rather than re-uploading an entire container image. This not only optimizes storage but also accelerates the deployment process, making it easier to maintain and distribute the applications in a variety of settings.

### SUMMARY

In various embodiments of the disclosure, a computer-implemented method for managing compute resources for containers is described. The computer-implemented method includes obtaining first usage data associated with at least one container. The obtained first usage data indicates a usage level of each compute resource of one or more compute resources by the at least one container. The computer-implemented method further includes obtaining a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the computer-implemented method includes comparing the obtained first usage data with the obtained set of threshold parameters. The computer-implemented method further includes detecting a first anomaly associated with a usage of the one or more compute resources by the at least one container. The first anomaly is detected based on the comparison of the obtained first usage data with the obtained set of threshold parameters. The computer-implemented method further includes determining a first set of allocation parameters associated with the at least one container based on the obtained first usage data and the detected first anomaly. The computer-implemented method includes generating a first allocation command for allocating the one or more compute resources to the at least one container. The first allocation command is generated based on the determined first set of allocation parameters.

In various embodiments of the disclosure, a computer system for managing compute resources for containers is described. The computer system includes a processor set, one or more computer-readable storage media, and program instructions stored on one or more computer-readable storage media. The program instructions executable by the processor set to cause the processor set to obtain first usage data associated with at least one container. The obtained first usage data indicates a usage level of each compute resource of one or more compute resources by the at least one container. The program instructions executable by the processor set to cause the processor set to obtain a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the program instructions executable by the processor set to cause the processor set to compare the obtained first usage data with the obtained set of threshold parameters. The program instructions executable by the processor set to cause the processor set to detect a first anomaly associated with a usage of the one or more compute resources by the at least one container. The first anomaly is detected based on the comparison of the obtained first usage data with the obtained set of threshold parameters. The program instructions executable by the processor set to cause the processor set to determine a first set of allocation parameters associated with the at least one container based on the obtained first usage data and the detected first anomaly. The program instructions executable by the processor set to cause the processor set to generate a first allocation command for allocating the one or more compute resources to the at least one container. The first allocation command is generated based on the determined first set of allocation parameters. The program instructions executable by the processor set to cause the processor set to allocate the one or more compute resources to the at least one container based on the generated first allocation command.

In various embodiments of the disclosure, a computer program product for managing compute resources for containers is described. The computer program product includes one or more computer-readable storage medium and program instructions stored on the one or more computer-readable storage media to perform operations. The operations include obtaining first usage data associated with at least one container. The obtained first usage data indicates a usage level of each compute resource of one or more compute resources by the at least one container. The operations include The operations further include obtaining a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the operations include comparing the obtained first usage data with the obtained set of threshold parameters. The operations further include detecting a first anomaly associated with a usage of the one or more compute resources by the at least one container. The first anomaly is detected based on the comparison of the obtained first usage data with the obtained set of threshold parameters. The operations include determining a first set of allocation parameters associated with the at least one container based on the obtained first usage data and the detected first anomaly. The operations include generating a first allocation command for allocating the one or more compute resources to the at least one container. The first allocation command is generated based on the determined first set of allocation parameters.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for the management of compute resources for containers, in accordance with an embodiment of the disclosure;

FIG. 2 is a diagram that illustrates a network environment for the management of the compute resources for the containers, in accordance with an embodiment of the disclosure;

FIG. 3 is a diagram that illustrates an architecture of a system for the management of the compute resources for the containers, in accordance with an embodiment of the disclosure;

FIG. 4 is a diagram that illustrates exemplary operations of the system for the management of the compute resources for the containers, in accordance with an embodiment of the disclosure;

FIG. 5 is a diagram that illustrates exemplary operations of a request assessment sub-system for the management of the compute resources for the containers, in accordance with an embodiment of the disclosure;

FIG. 6 is a diagram that illustrates exemplary operations of a resource usage monitoring sub-system for the management of the compute resources for the containers, in accordance with an embodiment of the disclosure;

FIG. 7 is a diagram that illustrates exemplary operations of a resource analysis sub-system for the management of the compute resources for the containers, in accordance with an embodiment of the disclosure;

FIG. 8 is a diagram that illustrates exemplary operations of a resource management sub-system for the management of the compute resources for the containers, in accordance with an embodiment of the disclosure;

FIG. 9 is a diagram that illustrates a first flowchart of an exemplary method for the management of the compute resources for the containers, in accordance with an embodiment of the disclosure; and

FIG. 10 is a diagram that illustrates a second flowchart of an exemplary method for the management of the compute resources for the containers, in accordance with an embodiment of the disclosure.

### DETAILED DESCRIPTION

In application development, containerization technology is used by developers to efficiently package applications along with their dependencies into standardized units called containers. This approach has revolutionized the deployment and scaling of the applications across diverse environments, enabling agility and consistency. However, as the reliance on the containerization technology grows, the requirement for effective resource management becomes increasingly critical, particularly in dynamic production settings where application performance and reliability are paramount.

Traditional architecture of the containerization technology allows a user to define one or more compute resources, such as CPU of a computing environment, memory of the computing environment, and disk I/O of the computing environment, to limit the resource usage of the containers. While the one or more compute resources provide a baseline for resource allocation, the challenge lies in achieving intelligent, dynamic, and automatic configuration of runtime containers. Existing methods used for the resource allocation fail to adapt to the fluctuating demands of the applications, leading to inefficient resource utilization and compromised performance. As organizations strive to optimize their containerized environments, the difficulty of managing the one or more compute resources in real-time and responding to changing workload conditions remains a persistent issue in production scenarios.

To address these challenges, the proposed system performs real-time and dynamic management of the one or more compute resources by automating the configuration of the runtime containers. The proposed system uses advanced processes, such as machine learning processes to monitor resource usage patterns and application performance metrics continuously. By analyzing this data, the proposed system can intelligently adjust resource allocation in real-time, ensuring that each runtime container operates at a defined run-rate while maintaining the performance and reliability standards. This dynamic management approach not only enhances resource utilization but also reduces the risk of performance degradation during peak workloads, ultimately providing a more resilient and responsive application environment.

In various embodiments of the disclosure, a computer-implemented method for managing compute resources for containers is described. The computer-implemented method includes obtaining first usage data associated with at least one container. The obtained first usage data indicates a usage level of each compute resource of one or more compute resources by the at least one container. The computer-implemented method further includes obtaining a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the computer-implemented method includes comparing the obtained first usage data with the obtained set of threshold parameters. The computer-implemented method further includes detecting a first anomaly associated with a usage of the one or more compute resources by the at least one container. The first anomaly is detected based on the comparison of the obtained first usage data with the obtained set of threshold parameters. The computer-implemented method further includes determining a first set of allocation parameters associated with the at least one container based on the obtained first usage data and the detected first anomaly. The computer-implemented method includes generating a first allocation command for allocating the one or more compute resources to the at least one container. The first allocation command is generated based on the determined first set of allocation parameters.

In various embodiments of the disclosure, the computer-implemented method further includes allocating the one or more compute resources to the at least one container to resolve the first anomaly. The one or more compute resources are allocated based on the generated first allocation command.

In various embodiments of the disclosure, the computer-implemented method further includes receiving a command to run the at least one container. The computer-implemented method further includes obtaining the first usage data based on the received command.

In various embodiments of the disclosure, the computer-implemented method includes extracting a set of keywords from the received command. Further, the computer-implemented method includes applying an Artificial intelligence (AI) model on the extracted set of keywords. Further, the computer-implemented method includes determining an objective of the received command based on the application of the AI model.

In various embodiments of the disclosure, the computer-implemented method includes obtaining second usage data associated with the at least one container based on the generation of the first allocation command. The second usage data is obtained within a defined time period subsequent to the obtaining of the first usage data. Furthermore, the computer-implemented method includes comparing the obtained second usage data with the obtained set of threshold parameters. The computer-implemented method includes detecting a second anomaly associated with the usage of the one or more compute resources by the at least one container. The second anomaly is detected based on the comparison of the obtained second usage data with the obtained set of threshold parameters. Further, the computer-implemented method includes determining a second set of allocation parameters associated with the at least one container based on the obtained second usage data, the obtained first usage data, and the detected second anomaly. The computer-implemented method includes generating a second allocation command based on the determined second set of allocation parameters. The second allocation command is generated to reallocate the one or more compute resources to the at least one container.

In various embodiments of the disclosure, the determined first set of allocation parameters correspond to resource allocation metrics of the one or more compute resources.

In various embodiments of the disclosure, the obtained first usage data includes at least one of system-level resource usage data, container-level resource usage data, or container status data.

In various embodiments of the disclosure, the one or more compute resources include at least one of a Central Processing Unit (CPU) of a computing environment, a memory of the computing environment, one or more network resources of the computing environment, or one or more Input/Output (I/O) components of the computing environment. The computing environment runs the at least one container.

In various embodiments of the disclosure, a computer system for managing compute resources for containers is described. The computer system includes a processor set, one or more computer-readable storage media, and program instructions stored on one or more computer-readable storage media. The program instructions executable by the processor set to cause the processor set to obtain first usage data associated with at least one container. The obtained first usage data indicates a usage level of each compute resource of one or more compute resources by the at least one container. The program instructions executable by the processor set to cause the processor set to obtain a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the program instructions executable by the processor set to cause the processor set to compare the obtained first usage data with the obtained set of threshold parameters. The program instructions executable by the processor set to cause the processor set to detect a first anomaly associated with a usage of the one or more compute resources by the at least one container. The first anomaly is detected based on the comparison of the obtained first usage data with the obtained set of threshold parameters. The program instructions executable by the processor set to cause the processor set to determine a first set of allocation parameters associated with the at least one container based on the obtained first usage data and the detected first anomaly. The program instructions executable by the processor set to cause the processor set to generate a first allocation command for allocating the one or more compute resources to the at least one container. The first allocation command is generated based on the determined first set of allocation parameters. The program instructions executable by the processor set to cause the processor set to allocate the one or more compute resources to the at least one container based on the generated first allocation command.

In various embodiments of the disclosure, the program instructions executable by the processor set to cause the processor set to receive a command to run the at least one container. Further, the program instructions executable by the processor set to cause the processor set to obtain the first usage data based on the received command.

In various embodiments of the disclosure, the program instructions executable by the processor set to cause the processor set to extract a set of keywords from the received command. Further, the program instructions executable by the processor set to cause the processor set to apply an Artificial intelligence (AI) model on the extracted set of keywords. Furthermore, the program instructions executable by the processor set to cause the processor set to determine an objective of the received command based on the application of the AI model.

In various embodiments of the disclosure, the program instructions executable by the processor set to cause the processor set to obtain second usage data associated with the at least one container based on the generation of the first allocation command. The second usage data is obtained within a defined time period from an instance when the first usage data is obtained. Furthermore, the program instructions executable by the processor set to cause the processor set to compare the obtained second usage data with the obtained set of threshold parameters. The program instructions executable by the processor set to cause the processor set to detect a second anomaly associated with the usage of the one or more compute resources by the at least one container. The second anomaly is detected based on the comparison of the obtained second usage data with the obtained set of threshold parameters. Further, the program instructions executable by the processor set to cause the processor set to determine a second set of allocation parameters associated with the at least one container based on the obtained second usage data, the obtained first usage data, and the detected second anomaly. The program instructions executable by the processor set to cause the processor set to generate a second allocation command based on the determined second set of allocation parameters. The second allocation command is generated to reallocate the one or more compute resources to the at least one container.

In various embodiments of the disclosure, the determined first set of allocation parameters correspond to quantitative values which indicate resource allocation metrics of the one or more compute resources.

In various embodiments of the disclosure, the obtained first usage data includes at least one of system-level resource usage data, container-level resource usage data, or container status data.

In various embodiments of the disclosure, the one or more compute resources include at least one of a Central Processing Unit (CPU) of a computing environment, a memory of the computing environment, one or more network resources of the computing environment, or one or more Input/Output (I/O) components of the computing environment. The computing environment runs the at least one container.

In various embodiments of the disclosure, a computer program product for managing compute resources for containers is described. The computer program product includes one or more computer-readable storage medium and program instructions stored on the one or more computer-readable storage media to perform operations. The operations include obtaining first usage data associated with at least one container. The obtained first usage data indicates a usage level of each compute resource of one or more compute resources by the at least one container. The operations include The operations further include obtaining a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the operations include comparing the obtained first usage data with the obtained set of threshold parameters. The operations further include detecting a first anomaly associated with a usage of the one or more compute resources by the at least one container. The first anomaly is detected based on the comparison of the obtained first usage data with the obtained set of threshold parameters. The operations include determining a first set of allocation parameters associated with the at least one container based on the obtained first usage data and the detected first anomaly. The operations include generating a first allocation command for allocating the one or more compute resources to the at least one container. The first allocation command is generated based on the determined first set of allocation parameters.

In various embodiments of the disclosure, the program instructions stored on the one or more computer-readable storage media perform operations including allocating the one or more compute resources to the at least one container to resolve the first anomaly. The one or more compute resources are allocated based on the generated first allocation command.

In various embodiments of the disclosure, the program instructions stored on the one or more computer-readable storage media perform operations including receiving a command to run the at least one container. The operations also include obtaining the first usage data based on the received command.

In various embodiments of the disclosure, the program instructions stored on the one or more computer-readable storage media perform operations including extracting a set of keywords from the received command. Further, the operations include applying an Artificial intelligence (AI) model on the extracted set of keywords. The operations also include determining an objective of the received command based on the application of the AI model.

In various embodiments of the disclosure, the program instructions stored on the one or more computer-readable storage media perform operations including obtaining second usage data associated with the at least one container based on the generation of the first allocation command. The second usage data is obtained within a defined time period subsequent to the obtaining of the first usage data. Further, the operations include comparing the obtained second usage data with the obtained set of threshold parameters. The operations also include detecting a second anomaly associated with the usage of the one or more compute resources by the at least one container. The second anomaly is detected based on the comparison of the obtained second usage data with the obtained set of threshold parameters. The operations include determining a second set of allocation parameters associated with the at least one container based on the obtained second usage data, the obtained first usage data, and the detected second anomaly. Furthermore, the operations include generating a second allocation command based on the determined second set of allocation parameters. The second allocation command is generated to reallocate the one or more compute resources to the at least one container.

In various embodiments of the disclosure, the determined first set of allocation parameters correspond to resource allocation metrics of the one or more compute resources.

In various embodiments of the disclosure, the obtained first usage data includes at least one of system-level resource usage data, container-level resource usage data, or container status data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

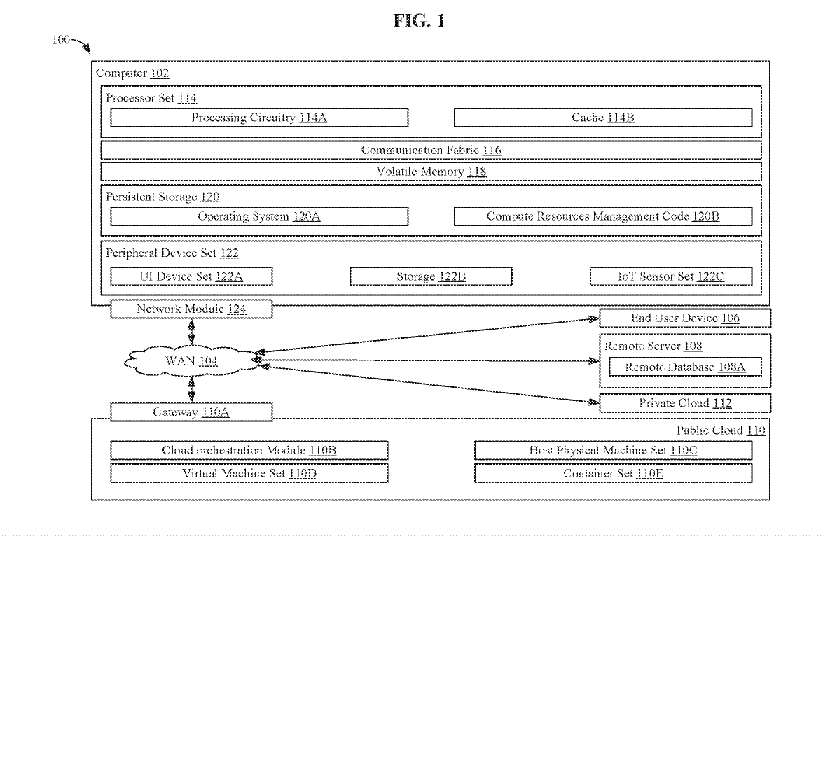

FIG. 1 is a diagram that illustrates a computing environment for the management of compute resources for containers, in accordance with an embodiment of the disclosure. With reference to FIG. 1, there is shown a computing environment 100 that contains an example of an environment for the execution of at least some of the computer code involved in performing the disclosed methods, such as a compute resources management code 120B. In addition to the compute resources management code 120B, the computing environment 100 includes, for example, a computer 102, a wide area network (WAN) 104, an end user device (EUD) 106, a remote server 108, a public cloud 110, and a private cloud 112. In various embodiments of the disclosure, the computer 102 includes a processor set 114 (including a processing circuitry 114A and a cache 114B), a communication fabric 116, a volatile memory 118, a persistent storage 120 (including an operating system 120A and the compute resources management code 120B (as identified above)), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future configured to run a program, accessing a network or querying a database, such as the remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In the computing environment 100, at least some of the instructions for performing the disclosed methods may be stored in the dynamic modification of the compute resources management code 120B in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the compute resources management code 120B typically includes at least some of the computer code involved in performing the disclosed methods.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In various embodiments of the disclosure, the storage 122B may take the form of a quantum computing storage device for storing data in the form of qubits. In various embodiments of the disclosure where the computer 102 is required to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that may be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In various embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to the computer 102 from an external computer or external storage device through a network adapter card or network interface included in the network module 124.

The WAN 104 is any wide area network (for example, the internet) configured to communicate computer data over non-local distances by any technology for communicating computer data, now known or to be developed in the future. In various embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation may typically be communicated from the network module 124 of the computer 102 through the WAN 104 to the EUD 106. In this way, the EUD 106 may display, or otherwise present recommendations to an end user. In various embodiments of the disclosure, the EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machines that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize resources of that computer, such as connected devices, files and folders, network shares, CPU power, and quantifiable hardware capabilities. However, programs running inside a container may only use the contents of the container and devices assigned to the container, a feature which is known as containerization.

The private cloud 112 may be similar to the public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

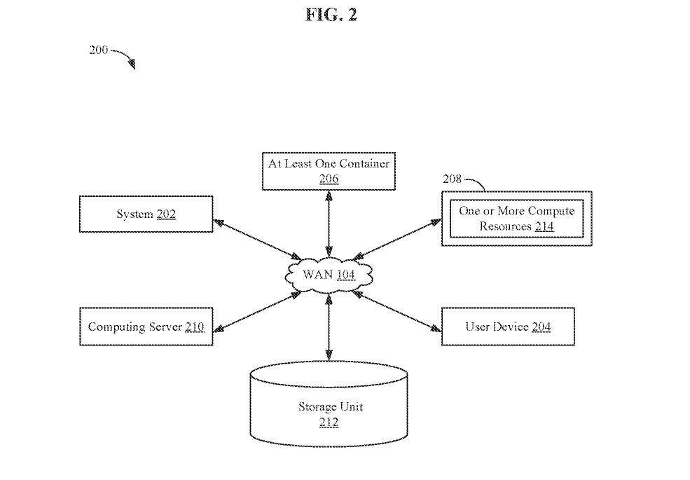

FIG. 2 is a diagram that illustrates a network environment for the management of the compute resources for the containers, in accordance with an embodiment of the disclosure. FIG. 2 is explained in conjunction with elements from FIG. 1. With reference to FIG. 2, there is shown a diagram of a network environment 200. The network environment 200 includes a system 202, a user device 204, at least one container 206, a computing environment 208 (e.g., the computing environment 100), and a computing server 210. Further, the network environment 200 also includes a storage unit 212, such as an internal storage unit and an external storage unit. The network environment 200 further includes a WAN 104 of FIG. 1. In an embodiment of the disclosure, the system 202 is an exemplary embodiment of the computer 102 in FIG. 1.

The system 202 may include suitable logic, circuitry, interfaces, and/or code that is configured for the management of one or more compute resources 214 for the at least one container 206. In an embodiment of the disclosure, the one or more compute resources 214 correspond to hardware components within the computing environment 208 that are utilized by the at least one container 206 to execute containerized applications. For example, the one or more compute resources 214 may include at least one of a Central Processing Unit (CPU) of the computing environment 208, a memory of the computing environment 208, one or more network resources of the computing environment 208, or one or more Input/Output (I/O) components of the computing environment 208. The CPU is configured to execute instructions and process data for running the containerized applications within the at least one container 206. Further, the memory, encompassing both volatile memory (e.g., Random Access Memory) and non-volatile memory (e.g., Secondary Storage Devices), is configured to store data and application states of the containerized applications during the execution of the containerized applications. Further, the one or more network resources enable communication between the at least one container 206 and external systems, enabling data transfer and service interactions. Furthermore, the one or more I/O components are configured to manage input and output operations of system components (e.g., disk drives and peripheral devices) used for the storage and retrieval of data.

In an embodiment of the disclosure, the computing environment 208 runs the at least one container 206. The at least one container 206 corresponds to encapsulated units that package an application and its dependencies, allowing it to run consistently across different computing environments. Further, the computing environment 208 corresponds to a comprehensive framework that encompasses the hardware, software, networks, and data storage systems for the operation and management of applications and services. For example, in the computing environment 208, multiple devices such as servers, workstations, and storage devices are interconnected through networks, allowing for seamless communication and data transfer.

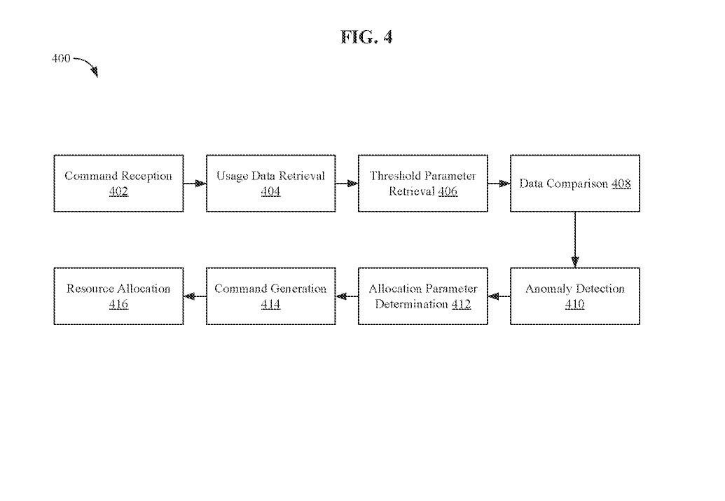

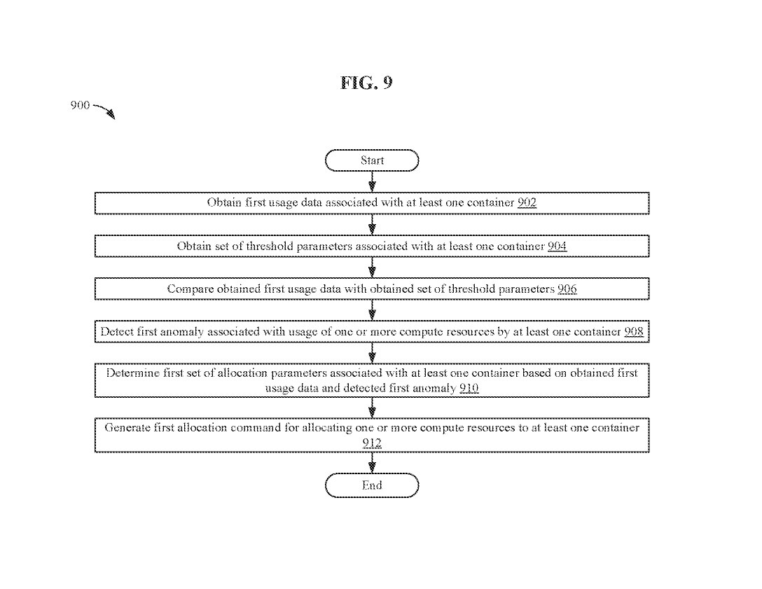

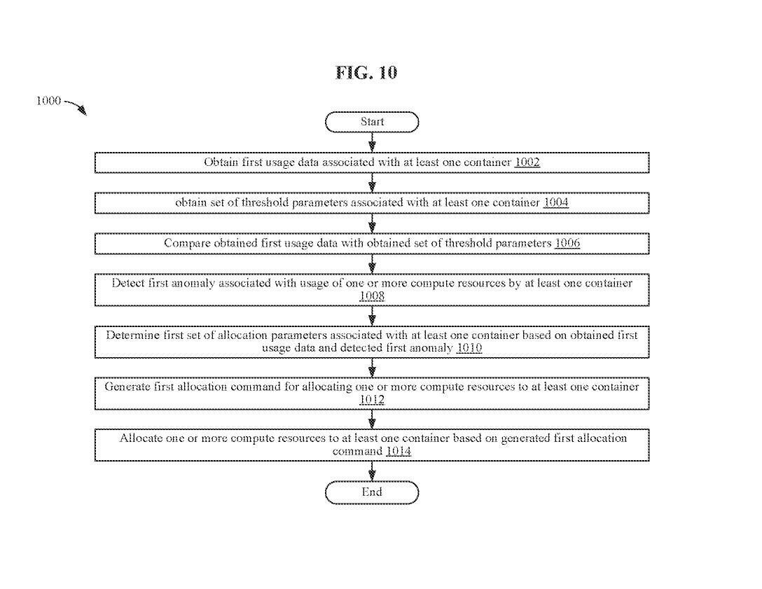

The system 202 may include suitable logic, circuitry, interfaces, and/or code that is configured for the management of the one or more compute resources 214 for the at least one container 206. The system 202 is configured to obtain first usage data associated with the at least one container 206. In an embodiment of the disclosure, the obtained first usage data indicates a usage level of each compute resource of the one or more compute resources 214 by the at least one container 206. Further, the system 202 is configured to obtain a set of threshold parameters associated with the at least one container 206. In an embodiment of the disclosure, the set of threshold parameters is obtained based on the obtained first usage data. The set of threshold parameters corresponds to the acceptable usage level of each compute resource of the one or more compute resources 214 by the at least one container 206. Details on obtaining the set of threshold parameters have been explained with reference to at least FIG. 4, FIG. 9, and FIG. 10.

Further, the system 202 is configured to compare the obtained first usage data with the obtained set of threshold parameters. Furthermore, the system 202 is configured to detect a first anomaly associated with a usage of the one or more compute resources 214 by the at least one container 206. In an embodiment of the disclosure, the first anomaly is detected based on the comparison of the obtained first usage data with the obtained set of threshold parameters. The system 202 is configured to determine a first set of allocation parameters associated with the at least one container 206 based on the obtained first usage data and the detected first anomaly. In an embodiment of the disclosure, the first set of allocation parameters corresponds to a collection of configurable settings that dictate how the one or more compute resources 214 may be allocated to the at least one container 206. The system 202 is further configured to generate a first allocation command for allocating the one or more compute resources 214 to the at least one container 206. In an embodiment of the disclosure, the first allocation command is generated based on the determined first set of allocation parameters. Details on generating the first allocation command have been explained with reference to, for example, FIG. 4, FIG. 9, and FIG. 10.

In an embodiment of the disclosure, each of the user device 204, the at least one container 206, and the computing environment 208 is connected independently to the system 202 using the WAN 104, such as 5G, 6G, and future wireless networks. This individual connectivity enables seamless and efficient data exchange between the system 202 and each of the user device 204, the at least one container 206, and the computing environment 208, allowing for real-time communication and the timely updating of data. By leveraging advanced wireless technologies such as 5G, 6G, and future networks, the system 202 can accommodate data throughput, ensuring that the management of the one or more compute resources 214 is performed without delay. This enables the system 202 to handle large volumes of data packets efficiently, support concurrent connections from multiple endpoints, and maintain data integrity during transmission, thereby optimizing the performance of distributed applications and enhancing the overall responsiveness of an architecture of the system 202.

Further, the user device 204 includes suitable logic, circuitry, interfaces, and/or code configured to input and transmit the command to the system 202, to run the at least one container 206. In an embodiment of the disclosure, the user device 204 is associated with a user. The user uses the user device 204 to input and transmit the command to the system 202. For example, the user may be a system administrator, a software developer, a cloud service provider, a cybersecurity professional, and the like. Further, the user device 204 ensures efficient communication with the system 202 through connectivity technologies like WAN, thereby supporting timely and secure data exchange. The user device 204 is communicatively coupled with the system 202 via the WAN 104. In an embodiment of the disclosure, the user device 204 is an exemplary embodiment of the EUD 106. Examples of the user device 204 may include, but are not limited to, a computing device, a smartphone, a mainframe machine, a server, a computer workstation, a cellular phone, a mobile phone, a gaming device, a consumer electronic (CE) device, a desktop computer, a laptop, a head-mounted device (HMD), and/or any additional electronic device. In an embodiment of the disclosure, the system 202 is implemented in the computing server 210. In an embodiment of the disclosure, the system 202 is implemented in the user device 204.

In an embodiment of the disclosure, a display screen of the user device 204 may include suitable logic, circuitry, and interfaces configured to receive the command. Further, the display screen provides a user-friendly interface where a user may input the command for running the at least one container 206. In an embodiment of the disclosure, the display screen may refer to a display screen of the smartphone, a display screen of the laptop, a display screen of the desktop computer, a display screen of a smart-glass device, a see-through display, a projection-based display, an electro-chromic display, or a transparent display. In an embodiment of the disclosure, the display screen is realized through several known technologies such as, but are not limited to, a Liquid Crystal Display (LCD) display, a Light Emitting Diode (LED) display, a plasma display, or an Organic LED (OLED) display technology, or additional display devices.

In an embodiment of the disclosure, the computing server 210 is implemented as a cloud server and may execute operations through web applications, cloud applications, HTTP requests, repository operations, file transfer, and the like. Further, exemplary implementations of the computing server 210 include, but are not limited to, a database server, a file server, a web server, a media server, an application server, a mainframe server, or a cloud computing server.

In an embodiment of the disclosure, the computing server 210 is implemented as a plurality of distributed cloud-based resources by use of several technologies that are well known to those ordinarily skilled in the art. A person with ordinary skill in the art will understand that the scope of the disclosure may not be limited to the implementation of the computing server 210 and the system 202 as two separate entities. In certain embodiments, the functionalities of the computing server 210 can be incorporated in its entirety or at least partially in the system 202, without a departure from the scope of the disclosure.

In an embodiment of the disclosure, the storage unit 212 is configured to store an organized collection of data. The organized collection of data can be accessed electronically from a computer system (such as the system 202). In an embodiment of the disclosure, the storage unit 212 is communicatively coupled to the user device 204. The storage unit 212 communicatively coupled to the user device 204 is configured to store various types of data related to the integration process. For example, the storage unit 212 securely stores the command, the first usage data, second usage data, the set of threshold parameters, and the like. Details on the second usage data have been explained with reference to at least FIG. 4.

In an embodiment of the disclosure, the storage unit 212 is communicatively coupled to the system 202 via the WAN 104. The storage unit 212 communicatively coupled to the system 202 stores data generated during the management processes of the one or more compute resources 214. The storage unit 212 enhances the capacity of the system 202 to archive the command, the first usage data, the second usage data, the set of threshold parameters, and the like. By leveraging the storage unit 212, the system 202 may be able to manage larger volumes of data effectively. Further, the storage unit 212 is designed to manage, store, retrieve, and update data associated with the management process of the one or more compute resources 214. The structure of the storage unit 212 involves tables, records, and fields that can be managed through various database management systems (DBMS). Examples of the storage unit 212 unit may include, but are not limited to, a relational database, a Non- Structured Query Language (SQL) database, a hierarchical database, a network database, a transactional database, a data warehouse, a distributed database, and a data lake.

In various embodiments of the disclosure, the system 202 is configured to obtain the first usage data associated with the at least one container 206. In an embodiment of the disclosure, the first usage data includes multiple metrics indicating how much of each compute resource of the one or more compute resources 214 is being utilized by the at least one container 206. For example, the first usage data is obtained through monitoring tools or Application Programming Interfaces (APIs) that track resource consumption of the one or more compute resources in real-time. Further, the system 202 is configured to obtain the set of threshold parameters associated with the at least one container 206. The set of threshold parameters corresponds to the acceptable usage level of each compute resource of the one or more compute resources 214 by the at least one container 206. Furthermore, the system 202 is configured to compare the obtained first usage data with the obtained set of threshold parameters. The comparison is performed to identify any discrepancies between the first usage data and the acceptable usage level of each compute resource of the one or more compute resources 214 defined by the set of threshold parameters. The system 202 is further configured to detect the first anomaly associated with the usage of the one or more compute resources 214 by the at least one container 206. The first anomaly corresponds to instances where the usage of the one or more compute resources 214 deviates from the set of threshold parameters. For example, if a container suddenly spikes to 90% CPU usage, this may be flagged as the first anomaly.

Further, the system 202 is configured to determine the first set of allocation parameters associated with the at least one container 206 based on the obtained first usage data and the detected first anomaly. In an embodiment of the disclosure, the first set of allocation parameters allows the system 202 to make informed decisions on how to adjust allocation of the one or more compute resources 214 to the at least one container 206. The system 202 is further configured to generate the first allocation command for allocating the one or more compute resources 214 to the at least one container 206. The allocation command specifies how the one or more compute resources 214 should be allocated or reallocated to the at least one container 206. For example, the allocation command may instruct the system 202 to increase the CPU allocation from 2 cores to 4 cores. The system 202 is further configured to allocate the one or more compute resources 214 to the at least one container 206 based on the generated first allocation command.

In operation, the system 202 is configured to obtain the first usage data associated with at least one container 206. Following the collection of usage data, the system 202 is configured to obtain the set of threshold parameters for the at least one container 206. The set of threshold parameters is obtained from the first usage data. In an embodiment of the disclosure, the system 202 is configured to compare the obtained first usage data with the set of threshold parameters. Based on the comparison, the system 202 is configured to determine whether the at least one container 206 is operating within the set of threshold parameters, or if the at least one container 206 is meeting or falling short of the set of threshold parameters. This proactive monitoring is used for maintaining the performance of the one or more compute resources 214 and preventing resource-related issues.

If the comparison signifies deviations, the system 202 detects the first anomaly associated with the usage of the one or more compute resources 214 by the at least one container 206. Detecting the first anomaly ensures that the at least one container 206 operates efficiently and does not negatively impact the overall performance of the computing environment 208. Once the first anomaly is detected, the system 202 is configured to determine the first set of allocation parameters based on the first usage data and the detected first anomaly. The first set of allocation parameters instructs the system on how the one or more compute resources 214 are to be adjusted to address the deviations. For example, if a container consistently satisfies its CPU threshold, the system 202 may allocate additional CPU resources to ensure the performance of the at least one container. The system 202 is configured to generate the first allocation command that specifies how the one or more compute resources 214 may be allocated or reallocated to the at least one container 206.

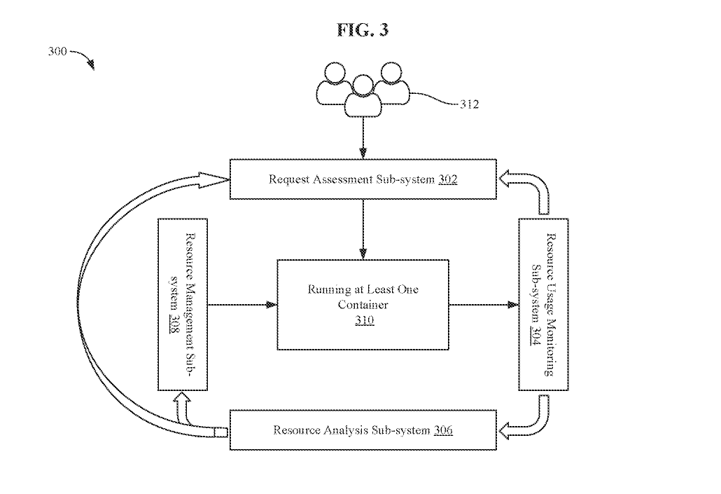

FIG. 3 is a diagram that illustrates an architecture of a system for the management of the compute resources for the containers, in accordance with an embodiment of the disclosure. FIG. 3 is explained in conjunction with elements from FIG. 1 and FIG. 2. With reference to FIG. 3, an architecture 300 of the system 202 illustrates a process flow for managing and optimizing the one or more compute resources 214 for the at least one container 206.

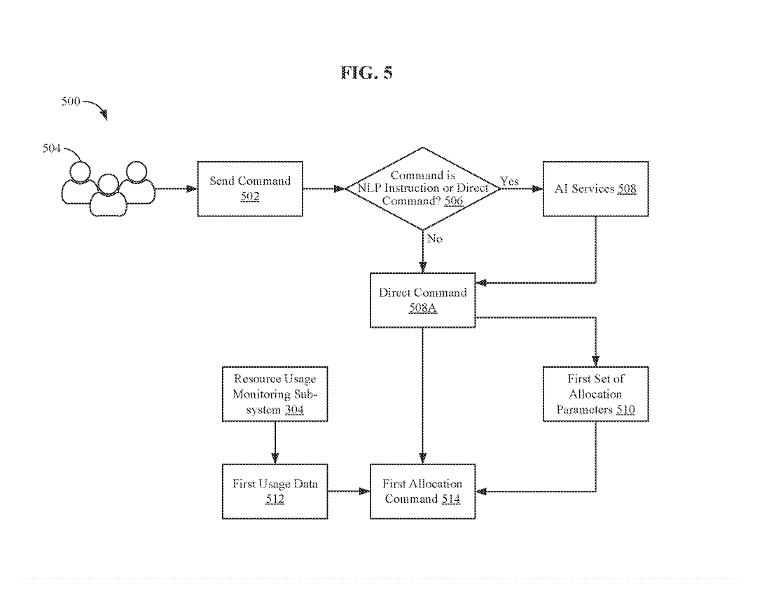

In an embodiment of the disclosure, the system 202 includes a request assessment sub-system 302, a resource usage monitoring sub-system 304, a resource analysis sub-system 306, and a resource management sub-system 308. In an embodiment of the disclosure, the system receives the request to run the at least one container 206 on the computing environment 208. In an embodiment of the disclosure, the at least one container 206 is run on the computing environment 208 upon receiving the request, at 310. When the request to run the at least one container 206 is received from a user 312, the request assessment sub-system 302 assesses the request and obtains the first usage data from the resource usage monitoring sub-system 304 and the first set of allocation parameters from the resource analysis sub-system 306. Further, the request assessment sub-system 302 uses the obtained first usage data and the obtained first set of allocation parameters to generate the first allocation command. By generating the first allocation command, the request assessment sub-system 302 ensures that the allocation of the one or more compute resources 214 meets the resource requirements of the at least one container 206. Details on the request assessment sub-system 302 have been explained with reference to at least FIG. 5.

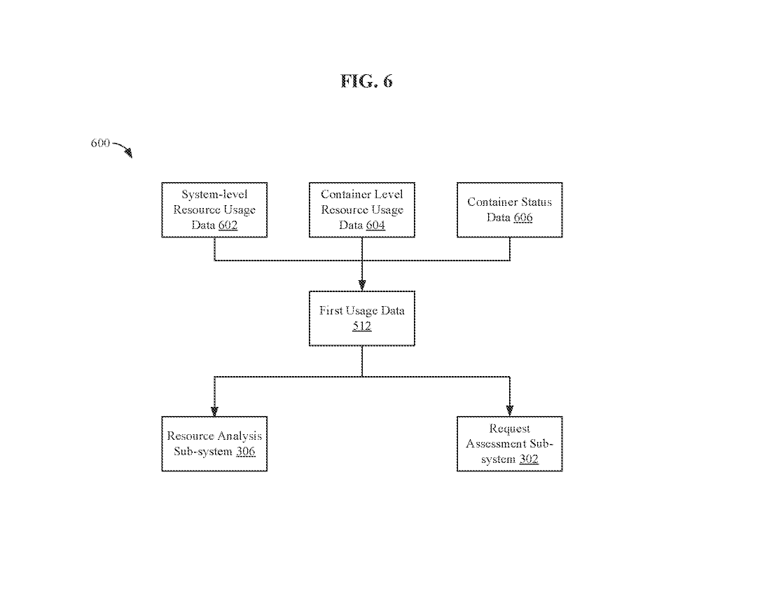

Further, the resource usage monitoring sub-system 304 continuously monitors system-level resource usage, container-level resource usage, and a status of the at least one container 206 in real-time. In an embodiment of the disclosure, the system-level resource usage refers to the overall utilization of the one or more compute resources 214 by an operating system and all processes running on the operating system. Further, the container-level resource usage focuses on the one or more compute resources 214 utilized by the at least one container 206 within the computing environment 208. In an embodiment of the disclosure, the resource usage monitoring sub-system 304 obtains the first usage data associated with the usage of the one or more compute resources 214 by the at least one container 206 and the computing environment 208. The first usage data is transmitted to both the resource analysis sub-system 306 for determining the first set of allocation parameters and the request assessment sub-system 302 for initial configuration adjustments of the one or more compute resources 214. Details on the resource usage monitoring sub-system 304 have been explained with reference to at least FIG. 6.

Further, the resource management sub-system 308 analyzes the first usage data in real-time to identify patterns in the first usage data, inefficiencies in the first usage data, and the first anomaly. In an embodiment of the disclosure, the patterns correspond to recognizable trends or behaviors in the first usage data that can indicate how the one or more compute resources 214 are being utilized over time. Further, the identification of the patterns helps in understanding the typical performance and resource requirements of the applications running in the at least one container 206. The inefficiencies refer to use of the one or more compute resources 214 that can lead to wasted capacity of the one or more compute resources 214, increased costs of the usage of the one or more compute resources 214, or degraded performance of the one or more compute resources 214. The identification of the inefficiencies is used for optimizing the allocation of the one or more compute resources 214. The resource management sub-system 308 processes the first usage data and the first anomaly to generate the first set of allocation parameters. The first set of allocation parameters is transmitted to the request assessment sub-system 302 for initial configuration adjustments of the one or more compute resources 214 and to the resource management sub-system 308 for dynamic management of the running at least one container 206.

Further, the resource management sub-system 308 manages the dynamic allocation of the one or more compute resources 214 to the running at least one container 206 based on the first set of allocation parameters. In an embodiment of the disclosure, the resource management sub-system 308 continuously adjusts the allocation of the one or more compute resources 214 to the at least one container 206 in real-time to ensure that the resource requirements of the at least one container 206 are met effectively. The resource management sub-system 308 acts on the feedback from the resource usage monitoring sub-system 304 (e.g., the first usage data) to make adjustments to the allocation of the one or more compute resources 214 to the at least one container 206 in real-time.

FIG. 4 is a diagram that illustrates exemplary operations of the system for the management of the compute resources for the containers, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 416, as described herein. The exemplary operations illustrated in the block diagram 400 start at 402 and are performed by any computing system, apparatus, or device, such as by the computer 102 of FIG. 1 or system 202 of FIG. 2. Although illustrated with discrete blocks, the exemplary operations associated with one or more blocks of the block diagram 400 are divided into additional blocks, combined into fewer blocks, or eliminated, depending on the particular implementation.

At 402, a command reception operation is performed. In the command reception operation, the system 202 is configured to receive the command to run the at least one container 206. In an embodiment of the disclosure, the command reception operation is performed by the request assessment sub-system 302 of the system 202.

In an embodiment of the disclosure, the system 202 is configured to extract a set of keywords from the received command. When the command is received, the system 202 analyzes the received command to identify the set of keywords for understanding the command's context and purpose. The set of keywords is identified using Natural Language Processing (NLP) processes, which may include tokenization (breaking down the received command into individual words or phrases), filtering out stop words (e.g., "and", "the", and the like), and identifying nouns, verbs, and the like in the received command. Further, the system 202 is configured to apply an Artificial intelligence (AI) model on the extracted set of keywords. The AI model (e.g., a machine learning or a deep learning model) is trained to understand the context and semantics of the set of key keywords. In an embodiment of the disclosure, the AI model processes the extracted set of keywords to classify the command, predict outcomes, or identify an objective behind the command. Furthermore, the system 202 is configured to determine the objective of the received command based on the application of the AI model. For example, the objective may include actions such as launching the at least one container 206, adjusting resource limits of the one or more compute resources 214, or performing a specific operation within the at least one container 206.

At 404, a usage data retrieval reception operation is executed. In the usage data retrieval reception operation, the system 202 is configured to obtain the first usage data associated with the at least one container 206. In an embodiment of the disclosure, the first usage data is obtained based on the received command. In an embodiment of the disclosure, the obtained first usage data indicates a usage level of each compute resource of the one or more compute resources 214 by the at least one container 206. For example, the one or more compute resources 214 include at least one of the CPU of the computing environment 208, the memory of the computing environment 208, the one or more network resources of the computing environment 208, or the one or more I/O components of the computing environment 208. In an embodiment of the disclosure, the computing environment 208 runs the at least one container 206. Further, the obtained first usage data includes at least one of system-level resource usage data, container-level resource usage data, or container status data. In an embodiment of the disclosure, the usage data retrieval reception operation is performed by the resource usage monitoring sub-system 304 of the system 202.

In an embodiment of the disclosure, the system-level resource usage data refers to metrics (e.g., CPU usage of the computing environment 208, memory usage of the computing environment 208, disk I/O of the computing environment 208, and network bandwidth of the computing environment 208) that provide insights into the overall resource consumption of the computing environment 208 where the at least one container 206 is running. Further, the container-level resource usage data focuses on the resource consumption of individual containers. For example, the container-level resource usage data includes CPU usage per container, memory consumption per container, disk usage per container, and network traffic per container. The container-level resource usage data is used for understanding how the at least one container 206 is performing and whether the at least one container 206 is operating within its allocated resource limits. Further, the container status data provides information about the operational state of the at least one container 206, such as whether a container is running, stopped, or in a failed state. The container status data is used for monitoring the health and lifecycle of the at least one container 206, ensuring the at least one container is running as expected.

At 406, a threshold parameter retrieval operation is executed. In the threshold parameter retrieval operation, the system 202 is configured to obtain the set of threshold parameters associated with the at least one container 206. In an embodiment of the disclosure, the set of threshold parameters is obtained based on the obtained first usage data. The set of threshold parameters corresponds to the acceptable usage level of each compute resource of the one or more compute resources 214 by the at least one container 206. For example, for a web application container, the set of threshold parameters may be set as follows: CPU usage may not meet 80%, memory usage may remain below 1.8 GB, and disk I/O may be capped at 150 MB/s.

At 408, a data comparison operation is executed. In the data comparison operation, the system 202 is configured to compare the obtained first usage data with the obtained set of threshold parameters. For example, the system 202 compares the container's CPU usage (70%) with a threshold associated with the CPU usage (80%). Since the container's CPU usage is within the acceptable usage level.

At 410, an anomaly detection operation is executed. In the anomaly detection operation, the system 202 is configured to detect the first anomaly associated with the usage of the one or more compute resources 214 by the at least one container 206. In an embodiment of the disclosure, the first anomaly is detected based on the comparison of the obtained first usage data with the obtained set of threshold parameters. In an embodiment of the disclosure, the system 202 flags any resource usage that satisfies the set of threshold parameters, indicating potential performance issues. For example, if the disk I/O is found to be 160 MB/s, the system 202 flags this as an anomaly since it satisfies the threshold of 150 MB/s. This could suggest that the at least one container 206 is experiencing a load, possibly due to increased traffic or inefficient data handling. In an embodiment of the disclosure, the threshold parameter retrieval operation, the data comparison operation, and the anomaly detection operation are performed by the resource analysis sub-system 306 of the system 202.

At 412, an allocation parameter determination operation is executed. In the allocation parameter determination operation, the system 202 is configured to determine the first set of allocation parameters associated with the at least one container 206 based on the obtained first usage data and the detected first anomaly. In an embodiment of the disclosure, the determined first set of allocation parameters correspond to resource allocation metrics of the one or more compute resources 214. The resource allocation metrics correspond to quantitative measures which are used to assess how the one or more compute resources 214 are to be distributed and utilized within the computing environment 208. The first set of allocation parameters enables the system 202 to adjust the allocation of the one or more compute resources 214 to address the first anomaly. This may involve increasing or decreasing resource limits based on the nature of the first anomaly. For example, in response to the detected first anomaly of disk I/O, the system 202 may determine that the at least one container 206 requires additional disk I/O bandwidth or that it should be optimized to reduce unrequired read/write operations.

At 414, a command generation operation is executed. In the command generation operation, the system 202 is configured to generate the first allocation command for allocating the one or more compute resources 214 to the at least one container 206. In an embodiment of the disclosure, the first allocation command is generated based on the determined first set of allocation parameters. The first allocation command instructs the system 202 on how to adjust the allocation of the one or more compute resources 214 for the at least one container 206. For example, the generated first allocation command may specify “increase disk I/O limit for container A to 200MB/s". In an embodiment of the disclosure, the command generation operation is performed by the request assessment sub-system 302 of the system 202.

At 416, a resource allocation operation is executed. In the resource allocation operation, the system 202 is configured to allocate the one or more compute resources 214 to the at least one container 206 to resolve the first anomaly. In an embodiment of the disclosure, the one or more compute resources are allocated based on the generated first allocation command. The resource allocation operation is performed by the resource management sub-system 308 of the system 202.

In an embodiment of the disclosure, the system 202 is configured to obtain second usage data associated with the at least one container 206 based on the generation of the first allocation command. In an embodiment of the disclosure, the second usage data is obtained within a defined time period subsequent to the obtaining of the first usage data. For example, the second usage data includes metrics such as CPU usage of the computing environment 208, memory consumption usage of the computing environment 208, disk I/O usage of the computing environment 208, and the like. The second usage data is used for assessing how the at least one container 206 is performing after allocating the one or more compute resources 214 to the at least one container 206 based on the first allocation command.

Further, the system 202 is configured to compare the obtained second usage data with the obtained set of threshold parameters. The set of threshold parameters are predefined limits that indicate when usage of the one or more compute resources 214 by the at least one container 206 is considered normal or excessive. Furthermore, the system 202 is configured to detect a second anomaly associated with the usage of the one or more compute resources 214 by the at least one container 206. In an embodiment of the disclosure, the second anomaly is detected based on the comparison of the obtained second usage data with the obtained set of threshold parameters. The second anomaly is detected when the second usage data deviates from the set of threshold parameters. The second anomaly is used for proactive resource management, as it enables the system 202 to respond to anomalies before they impact the application's performance running in the at least one container.

Furthermore, the system 202 is configured to determine a second set of allocation parameters associated with the at least one container 206 based on the obtained second usage data, the obtained first usage data, and the detected second anomaly. For example, the second set of allocation parameters may include adjustments to CPU, memory limits, and the like to address the detected second anomaly. The system 202 is configured to generate a second allocation command based on the determined second set of allocation parameters. In an embodiment of the present disclosure, the second allocation command is generated to reallocate the one or more compute resources 214 to the at least one container. The second allocation command ensures that the at least one container 206 has the compute resources to operate effectively and mitigate any performance issues (e.g., the second anomaly).

FIG. 5 is a diagram that illustrates exemplary operations of the request assessment sub-system for the management of the compute resources for the containers, in accordance with an embodiment of the disclosure. FIG. 5 is explained in conjunction with elements from FIG. 1, FIG. 2, FIG. 3, and FIG. 4.

As shown in a diagram 500, at 502, the user 504 sends the command to the system 202 for running the at least one container 206. In an embodiment of the disclosure, the request assessment sub-system 302 receives the command. The command may be in two forms, such as a Natural Language Processing (NLP) instruction or a direct command. For example, the NLP instruction may be "allocate 4GB of memory to the at least one container 206". In an embodiment of the disclosure, direct command corresponds to explicit commands that already specify the actions, such as docker run --memory=4GB.

Further, at 506, the request assessment sub-system 302 determines whether the command is an NLP instruction or a direct command. If the command is the NLP instruction, the command is sent to AI model services 508 (e.g., large language model) for processing the command. Further, if the command is the direct command, the request assessment sub-system 302 bypasses the AI model services 508 and moves to 510.

In an embodiment of the disclosure, AI model services 508 converts the natural language instruction into the direct command that the system 202 can execute, at 508A. Further, the request assessment sub-system 302 or the resource analysis sub-system 306 determines the first set of allocation parameters 510 associated with the at least one container 206 based on the received command, the first usage data 512, and the first anomaly. Further, the request assessment sub-system 302 receives the first usage data 512 from the resource usage monitoring sub-system 304. Furthermore, the request assessment sub-system 302 generates the first allocation command 514 for allocating the one or more compute resources 214 to the at least one container 206. In an embodiment of the disclosure, the first allocation command 514 is generated based on the first set of allocation parameters 510, the first usage data 512, and the received command. The first allocation command 514 ensures that the one or more compute resources 214 are allocated, such that over-provisioning of the one or more compute resources 214, or under-provisioning of the one or more compute resources 214 may be avoided.

For example, the command may be “podman run my_image”. The first allocation command 514 generated for the memory may be “podman run -m 256m --memory-swap 1g my_image”. Further, the first allocation command 514 generated for the memory and the CPU may be “podman run -m 256m --memory-swap 1g --cpus=2 my_image”. Furthermore, the first allocation command 514 generated for the memory, the I/O components and the CPU may be “podman run -m 256m --memory-swap 1g --cpus=2 --device-read-bps /dev/sda:10MB my_image”.

FIG. 6 is a diagram that illustrates exemplary operations of the resource usage monitoring sub-system for the management of the compute resources for the containers, in accordance with an embodiment of the disclosure. FIG. 6 is explained in conjunction with elements from FIG. 1, FIG. 2, FIG. 3, FIG. 4, and FIG. 5.

As shown in a diagram 600 of FIG. 6, the resource usage monitoring sub-system 304 of the system 202 continuously monitors the system-level resource usage data 602 (e.g., data associated with a physical or virtual machine hosting the at least one container 206), the container-level resource usage data 604 (e.g., data associated with individual containers running the applications), and the container status data 606. For example, the system-level resource usage data 602 includes metrics such as CPU usage, memory consumption, disk I/O, and network bandwidth for the entire physical machine (e.g., the computing environment 208). Monitoring the system-level resource usage data 602 ensures that the underlying infrastructure of the computing environment 208 has sufficient compute resources to support all running containers and applications. Further, the container-level resource usage data 604 focuses on the resource consumption of individual containers. For example, the container-level resource usage data 604 includes CPU usage per container, memory consumption per container, disk usage per container, and network traffic per container. Furthermore, the container status data 606 provides information about the operational state of the at least one container 206, such as whether a container is running, stopped, or in a failed state.

Further, the resource usage monitoring sub-system 304 uses the system-level resource usage data 602, the container-level resource usage data 604, and the container status data 606 to determine the first usage data 512 of the one or more compute resources 214 in real-time. The first usage data 512 is used for continuously checking the health and status of each container. For example, the first usage data 512 is used to determine if a container is running as expected, whether the container is in a running, stopped, or crashed state, and the like. Further, the resource usage monitoring sub-system 304 performs real-time monitoring of the operational status of containers based on the first usage data 512 to identify containers that are behaving abnormally. For example, the containers behaving abnormally may consume more CPU or memory than expected, which may indicate a memory leak or inefficient processing. Furthermore, the resource usage monitoring sub-system 304 transmits the first usage data 512 to the resource analysis sub-system 306 and the request assessment sub-system 302.

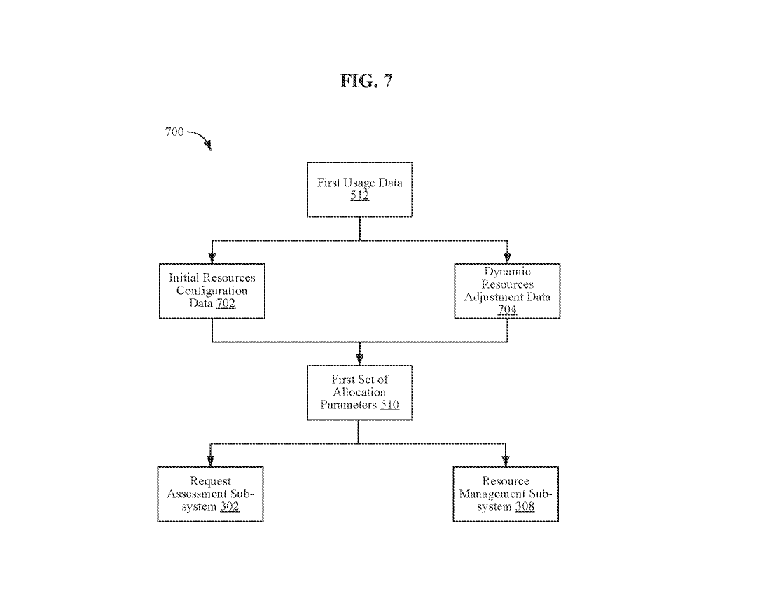

FIG. 7 is a diagram that illustrates exemplary operations of the resource analysis sub-system for the management of the compute resources for the containers, in accordance with an embodiment of the disclosure. FIG. 7 is explained in conjunction with elements from FIG. 1, FIG. 2, FIG. 3, FIG. 4, FIG. 5, and FIG. 6.

As shown in a diagram 700, the resource analysis sub-system 306 receives the first usage data 512 from the resource usage monitoring sub-system 304. Further, the resource analysis sub-system 306 determines initial resources configuration data 702 and dynamic resources adjustment data 704 based on the received first usage data 512. In an embodiment of the disclosure, the initial resources configuration data 702 corresponds to the baseline or starting configuration of the one or more compute resources 214 allocated to the at least one container 206. Further, the dynamic resources adjustment data 704 indicates the adjustments made to resource allocations during runtime, based on observed anomalies or changing requirements of the at least one container 206.

Further, the resource analysis sub-system 306 generates the first set of allocation parameters 510 based on the initial resources configuration data 702 and dynamic resources adjustment data 704. The resource analysis sub-system 306 transmits the generated first set of allocation parameters 510 to the request assessment sub-system 302 and the resource management sub-system 308.

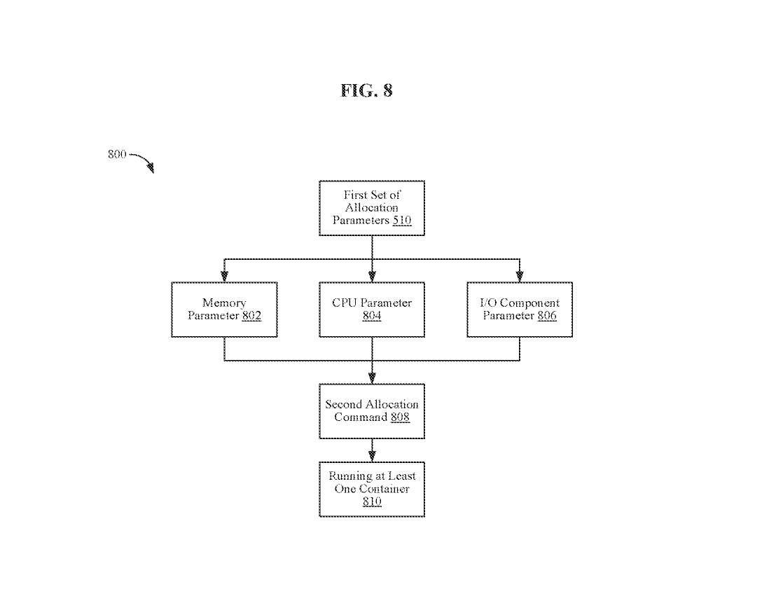

FIG. 8 is a diagram that illustrates exemplary operations of the resource management sub-system for the management of the compute resources for the containers, in accordance with an embodiment of the disclosure. FIG. 8 is explained in conjunction with elements from FIG. 1, FIG. 2, FIG. 3A, FIG. 3B, FIG. 4, FIG. 5, FIG. 6, and FIG. 7.

As shown in a diagram 800, the resource management sub-system 308 receives the first set of allocation parameters 510 from the resource analysis sub-system 306. Further, the resource management sub-system 308 detects the second anomaly based on the second usage data, the received first set of allocation parameters 510, and the set of threshold parameters. Further, the resource management sub-system 308 generates the second set of allocation parameters associated with the at least one container 206 based on the second usage data, the first usage data 512, and the detected second anomaly. For example, the second set of allocation parameters may include memory parameter 802, CPU parameter 804, and I/O component parameter 806. In an embodiment of the disclosure, the memory parameter 802 specifies adjustments to the memory allocation for the at least one container 206. Further, the CPU parameter 804 specifies adjustments to the CPU allocation for the at least one container 206. The I/O component parameter 806 specifies adjustments to the I/O component allocation for the at least one container 206.

Further, the resource management sub-system 308 generates the second allocation command 808 based on the second set of allocation parameters. In an embodiment of the disclosure, the second set allocation command is generated by combining the memory parameter 802, the CPU parameter 804, and the I/O component parameter 806. Furthermore, the second allocation command 808 is applied to the running at least one container 810, dynamically adjusting allocations of the one or more compute resources 214 in real-time.

For example, the memory parameter 802 for dynamically adjusting the memory of the computing environment 208 is “podman update -m 256m --memory-swap 1g my_image”. The CPU parameter 804 for dynamically adjusting the CPU of the computing environment 208 is “podman update --cpus=2 my_image”. Furthermore, the I/O component parameter 806 for dynamically adjusting the one or more I/O components of the computing environment 208 is “podman update --device-read-bps /dev/sda:10MB my_image”. The resource management sub-system 308 generates the second allocation command 808 “podman update -m 256m --memory-swap 1g -- cpus=2 --device-read-bps /dev/sda:10MB my_image”.

In a use-case scenario, the request assessment sub-system 302 of the system 202 receives the command “podman run ubuntu”. Further, the request assessment sub-system 302 of the system 202 generates the first allocation command 514 for the memory “podman run -m 256m --memory-swap 1g ubuntu”. The request assessment sub-system 302 of the system 202 also generates the first allocation command 514 for the memory and CPU “podman run -m 256m --memory-swap 1g --cpus=2 ubuntu”. Furthermore, the request assessment sub-system 302 of the system 202 also generates the first allocation command 514 for the memory, the one or more I/O components, and the CPU “podman run -m 256m --memory-swap 1g --cpus=2 --device-read-bps /dev/sda:10MB ubuntu”. The resource management sub-system 308 generates the second allocation command 808 “podman update -m 1g --memory-swap 512m --cpus=1 --device-read-bps /dev/sda:15MB ubuntu”.

FIG. 9 is a diagram that illustrates a first flowchart of an exemplary method for the management of compute resources for the containers, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. The operations of the exemplary computer-implemented method are executed by any computing system, for example, by the computer 102 of FIG. 1 or the system 202 of FIG. 2. The operations of a first flowchart 900 may start at 902.

At 902, first usage data 512 associated with at least one container 206 is obtained. In an embodiment of the disclosure, the obtained first usage data 512 indicates a usage level of each compute resource of one or more compute resources 214 by the at least one container 206. In an embodiment of the disclosure, the system 202 is configured to obtain the first usage data 512 associated with at least one container 206. For example, the one or more compute resources 214 may include at least one of a Central Processing Unit (CPU) of a computing environment 208, a memory of the computing environment 208, one or more network resources of the computing environment 208, or one or more Input/Output (I/O) components of the computing environment 208. In an embodiment of the disclosure, the computing environment 208 runs the at least one container 206. The first usage data 512 is gathered through monitoring tools or APIs that track resource consumption in real-time. In an embodiment of the disclosure, the first usage data 512 provides a baseline understanding of how much of each compute resource of the one or more compute resources 214 is currently used by the at least one container 206. In an embodiment of the disclosure, the first usage data 512 may include at least one of system-level resource usage data 602, container-level resource usage data 604, or container status data 606. For example, the first usage data 512 is represented in metrics, such as CPU usage in percentage, memory usage in megabytes, and I/O operations per second. Details about obtaining the first usage data 512 are provided, for example, in FIG. 2, FIG. 4, and FIG. 10.

At 904, a set of threshold parameters associated with the at least one container 206 is obtained. In an embodiment of the disclosure, the set of threshold parameters is obtained based on the obtained first usage data 512. The set of threshold parameters corresponds to the acceptable usage level of each compute resource of the one or more compute resources 214 by the at least one container 206. In an embodiment of the disclosure, the system 202 is configured to obtain the set of threshold parameters associated with the at least one container 206. Details about obtaining the set of threshold parameters are provided, for example, in FIG. 2, FIG. 4, and FIG. 10.

At 906, the obtained first usage data 512 is compared with the obtained set of threshold parameters. In an embodiment of the disclosure, the system 202 is configured to compare the obtained first usage data 512 with the obtained set of threshold parameters. The comparison is performed to identify whether the current resource usage of the one or more compute resources 214 falls within acceptable limits. In an embodiment of the disclosure, the system 202 checks the usage level of each compute resource of the one or more compute resources 214 against its corresponding threshold to determine if any compute resource is being over-utilized or under-utilized. Details about the comparison of the obtained first usage data 512 with the obtained set of threshold parameters are provided, for example, in FIG. 2, FIG. 4, and FIG. 10.

At 908, a first anomaly associated with a usage of the one or more compute resources 214 by the at least one container 206 is detected. In an embodiment of the disclosure, the first anomaly is detected based on the comparison of the obtained first usage data with the obtained set of threshold parameters. In an embodiment of the disclosure, the system 202 is configured to detect the first anomaly associated with the usage of the one or more compute resources 214 by the at least one container 206. For example, the first anomaly may occur when the usage of a compute resource satisfies the defined threshold (e.g., the set of threshold parameters), indicating potential issues, such as resource contention, inefficient application performance, or unexpected spikes in demand. Details on detecting the first anomaly are provided, for example, in FIG. 2, FIG. 4, and FIG. 10.

At 910, a first set of allocation parameters 510 associated with the at least one container 206 is determined based on the obtained first usage data 512 and the detected first anomaly. In an embodiment of the disclosure, the system 202 is configured to determine the first set of allocation parameters 510 associated with the at least one container 206 based on the obtained first usage data 512 and the detected first anomaly. In an embodiment of the disclosure, the determined first set of allocation parameters 510 correspond to resource allocation metrics of the one or more compute resources 214. Details on determining the first set of allocation parameters 510 are provided, for example, in FIG. 2, FIG. 4, and FIG. 10.

At 912, a first allocation command 514 is generated for allocating the one or more compute resources 214 to the at least one container 206. The first allocation command 514 is generated based on the determined first set of allocation parameters 510. In an embodiment of the disclosure, the system 202 is configured to generate the first allocation command 514 for allocating the one or more compute resources 214 to the at least one container 206. For example, the first allocation command 514 specifies how the one or more compute resources 214 are to be allocated to the at least one container 206, such as increasing CPU limits, adjusting memory allocations, modifying I/O bandwidth, and the like. Details about the generation of the first allocation command 514 are provided, for example, in FIG. 2, FIG. 4, and FIG. 10.

While the above operation of the system 202 shown in FIG. 9 is described in a particular sequence, the operation of the system 202 may occur in variations to the sequence in accordance with various embodiments of the disclosure. Further, details related to the operation of FIG. 9, which are already covered in the description related to FIG. 1 to FIG. 8 are not discussed again in detail here for the sake of brevity.

FIG. 10 is a diagram that illustrates a second flowchart of an exemplary method for the management of the compute resources for the containers, in accordance with an embodiment of the disclosure. FIG. 10 is explained in conjunction with elements from FIG. 1, FIG. 2, FIG. 3, FIG. 4, FIG. 5, FIG. 6, FIG. 7, FIG. 8, and FIG. 9. The operations of the exemplary computer-implemented method are executed by any computing system, for example, by the computer 102 of FIG. 1 or the system 202 of FIG. 2. The operations of a second flowchart 1000 may start at 1002.

At 1002, first usage data 512 associated with at least one container 206 is obtained. In an embodiment of the disclosure, the obtained first usage data 512 indicates a usage level of each compute resource of one or more compute resources 214 by the at least one container 206. In an embodiment of the disclosure, the system 202 is configured to obtain the first usage data 512 associated with at least one container 206. For example, the one or more compute resources 214 may include the one or more compute resources 214 including at least one of a Central Processing Unit (CPU) of a computing environment 208, a memory of the computing environment 208, one or more network resources of the computing environment 208, or one or more Input/Output (I/O) components of the computing environment 208. Details about obtaining the first usage data 512 are provided, for example, in FIG. 2, FIG. 4, and FIG. 9.

At 1004, a set of threshold parameters associated with the at least one container 206 is obtained. In an embodiment of the disclosure, the set of threshold parameters is obtained based on the obtained first usage data 512. The set of threshold parameters corresponds to the acceptable usage level of each compute resource of the one or more compute resources 214 by the at least one container 206. In an embodiment of the disclosure, the system 202 is configured to obtain the set of threshold parameters associated with the at least one container 206. Details about obtaining the set of threshold parameters are provided, for example, in FIG. 2, FIG. 4, and FIG. 9.

At 1006, the obtained first usage data 512 is compared with the obtained set of threshold parameters. In an embodiment of the disclosure, the system 202 is configured to compare the obtained first usage data 512 with the obtained set of threshold parameters. The comparison is performed to identify whether the current resource usage of the one or more compute resources 214 falls within acceptable limits. Details about the comparison of the obtained first usage data 512 with the obtained set of threshold parameters are provided, for example, in FIG. 2, FIG. 4, and FIG. 9.

At 1008, first anomaly associated with a usage of the one or more compute resources 214 by the at least one container 206 is detected. In an embodiment of the disclosure, the first anomaly is detected based on the comparison of the obtained first usage data with the obtained set of threshold parameters. In an embodiment of the disclosure, the system 202 is configured to detect the first anomaly associated with the usage of the one or more compute resources 214 by the at least one container 206. For example, the first anomaly may occur when the usage of a compute resource satisfies the defined threshold (e.g., the set of threshold parameters), indicating potential issues, such as resource contention, inefficient application performance, or unexpected spikes in demand. Details on detecting the first anomaly are provided, for example, in FIG. 2, FIG. 4, and FIG. 9.

At 1010, a first set of allocation parameters 510 associated with the at least one container 206 is determined based on the obtained first usage data 512 and the detected first anomaly. In an embodiment of the disclosure, the system 202 is configured to determine the first set of allocation parameters 510 associated with the at least one container 206 based on the obtained first usage data 512 and the detected first anomaly. In an embodiment of the disclosure, the determined first set of allocation parameters 510 corresponds to resource allocation metrics of the one or more compute resources 214. Details on determining the first set of allocation parameters 510 are provided, for example, in FIG. 2, FIG. 4, and FIG. 9.

At 1012, a first allocation command 514 is generated for allocating the one or more compute resources 214 to the at least one container 206. The first allocation command 514 is generated based on the determined first set of allocation parameters 510. In an embodiment of the disclosure, the system 202 is configured to generate the first allocation command 514 for allocating the one or more compute resources 214 to the at least one container 206. Details about the generation of the first allocation command 514 are provided, for example, in FIG. 2, FIG. 4, and FIG. 9.

At 1014, the one or more compute resources 214 are allocated to the at least one container 206 to resolve the first anomaly. In an embodiment of the disclosure, the system 202 is configured to allocate the one or more compute resources 214 to the at least one container 206 to resolve the first anomaly. The one or more compute resources 214 are allocated based on the generated first allocation command 514. Details about the allocation of the one or more compute resources 214 to the at least one container 206 are provided, for example, in FIG. 2 and FIG. 4.

While the above operation of the system 202 shown in FIG. 10 is described in a particular sequence, the operation may occur in variations to the sequence in accordance with various embodiments of the disclosure. Further, details related to the operation of FIG. 10, which is already covered in the description related to FIG. 1 to FIG. 9 are not discussed again in detail here for the sake of brevity.

The system 202 presents multiple advantages. By enabling dynamic memory allocation tailored to the specific requirements of each container, the system 202 optimizes memory usage, allowing for more containers to run simultaneously without requiring additional hardware resources. This efficient use of memory is complemented by the ability to adjust CPU allocations in real-time, ensuring that processor resources are utilized effectively. As a result, applications running within the containers experience improved performance and responsiveness, as CPU resources are allocated precisely.

Further, the system 202 addresses I/O bottlenecks by dynamically managing operations of the one or more I/O components based on the current demands of the one or more compute resources 214. As a result, the performance degradation may be avoided which can occur when multiple containers compete for limited I/O resources. Beyond hardware efficiency, the system 202 automates real-time management of running containers without the requirement for reboot operations, significantly minimizing downtime and maintaining service availability. The system 202 also optimizes resource usage just before starting a container, ensuring that each container is allocated the appropriate resources from the outset, which reduces the likelihood of performance issues.

Furthermore, the system 202 automatically processes containers that encounter issues, preventing resource wastage and enhancing reliability. This proactive approach not only resolves problems swiftly but also contributes to the overall stability of the system 202. The system 202 increases container deployment productivity and efficiency by streamlining resource allocation processes. With automated adjustments and optimizations, developers can focus on building and deploying applications rather than managing the one or more compute resources 214 manually, leading to faster deployment cycles and improved operational efficiency.

In various embodiments of the disclosure, a computer program product for managing compute resources for containers is described. The computer program product includes one or more computer-readable storage medium and program instructions stored on the one or more computer-readable storage media to perform operations. The operations include obtaining first usage data associated with at least one container. The obtained first usage data indicates a usage level of each compute resource of one or more compute resources by the at least one container. The operations include The operations further include obtaining a set of threshold parameters associated with the at least one container. The set of threshold parameters is obtained based on the obtained first usage data. Further, the set of threshold parameters corresponds to acceptable usage level of each compute resource of the one or more compute resources by the at least one container. Furthermore, the operations include comparing the obtained first usage data with the obtained set of threshold parameters. The operations further include detecting a first anomaly associated with a usage of the one or more compute resources by the at least one container. The first anomaly is detected based on the comparison of the obtained first usage data with the obtained set of threshold parameters. The operations include determining a first set of allocation parameters associated with the at least one container based on the obtained first usage data and the detected first anomaly. The operations include generating a first allocation command for allocating the one or more compute resources to the at least one container. The first allocation command is generated based on the determined first set of allocation parameters.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by a computer, first usage data associated with at least one container, wherein the obtained first usage data indicates a usage level of each compute resource of one or more compute resources by the at least one container;
obtaining, by the computer, a set of threshold parameters associated with the at least one container, wherein the set of threshold parameters is obtained based on the obtained first usage data, and wherein the set of threshold parameters corresponds to acceptable usage level of each compute resource of the one or more compute resources by the at least one container;
comparing, by the computer, the obtained first usage data with the obtained set of threshold parameters;
detecting, by the computer, a first anomaly associated with a usage of the one or more compute resources by the at least one container, wherein the first anomaly is detected based on the comparison of the obtained first usage data with the obtained set of threshold parameters;
determining, by the computer, a first set of allocation parameters associated with the at least one container based on the obtained first usage data and the detected first anomaly; and
generating, by the computer, a first allocation command for allocating the one or more compute resources to the at least one container, wherein the first allocation command is generated based on the determined first set of allocation parameters.

2. The computer-implemented method of claim 1, further comprising:
allocating, by the computer, the one or more compute resources to the at least one container to resolve the first anomaly, wherein the one or more compute resources are allocated based on the generated first allocation command.

3. The computer-implemented method of claim 1, further comprising:
receiving, by the computer, a command to run the at least one container; and
obtaining, by the computer, the first usage data based on the received command.

4. The computer-implemented method of claim 3, further comprising:
extracting, by the computer, a set of keywords from the received command;
applying, by the computer, an Artificial intelligence (AI) model on the extracted set of keywords; and
determining, by the computer, an objective of the received command based on the application of the AI model.

5. The computer-implemented method of claim 1, further comprising:
obtaining, by the computer, second usage data associated with the at least one container based on the generation of the first allocation command, wherein the second usage data is obtained within a defined time period subsequent to the obtaining of the first usage data;
comparing, by the computer, the obtained second usage data with the obtained set of threshold parameters;
detecting, by the computer, a second anomaly associated with the usage of the one or more compute resources by the at least one container, wherein the second anomaly is detected based on the comparison of the obtained second usage data with the obtained set of threshold parameters;
determining, by the computer, a second set of allocation parameters associated with the at least one container based on the obtained second usage data, the obtained first usage data, and the detected second anomaly; and
generating, by the computer, a second allocation command based on the determined second set of allocation parameters, wherein the second allocation command is generated to reallocate the one or more compute resources to the at least one container.

6. The computer-implemented method of claim 1, wherein the determined first set of allocation parameters correspond to resource allocation metrics of the one or more compute resources.

7. The computer-implemented method of claim 1, wherein the obtained first usage data comprises at least one of system-level resource usage data, container-level resource usage data, or container status data.

8. The computer-implemented method of claim 1, wherein the one or more compute resources comprise at least one of a Central Processing Unit (CPU) of a computing environment, a memory of the computing environment, one or more network resources of the computing environment, or one or more Input/Output (I/O) components of the computing environment, and wherein the computing environment runs the at least one container.

9. A computer system, comprising:
a processor set;
one or more computer-readable storage media; and
program instructions stored on the one or more computer-readable storage media, the program instructions executable by the processor set to cause the processor set to:
obtain first usage data associated with at least one container, wherein the obtained first usage data indicates a usage level of each compute resource of one or more compute resources by the at least one container;
obtain a set of threshold parameters associated with the at least one container, wherein the set of threshold parameters is obtained based on the obtained first usage data, and wherein the set of threshold parameters corresponds to acceptable usage level of each compute resource of the one or more compute resources by the at least one container;
compare the obtained first usage data with the obtained set of threshold parameters;
detect a first anomaly associated with a usage of the one or more compute resources by the at least one container, wherein the first anomaly is detected based on the comparison of the obtained first usage data with the obtained set of threshold parameters;
determine a first set of allocation parameters associated with the at least one container based on the obtained first usage data and the detected first anomaly;
generate a first allocation command to allocate the one or more compute resources to the at least one container, wherein the first allocation command is generated based on the determined first set of allocation parameters; and
allocate the one or more compute resources to the at least one container to resolve the first anomaly, wherein the one or more compute resources are allocated based on the generated first allocation command.

10. The computer system of claim 9, wherein the program instructions further cause the processor set to:
receive a command to run the at least one container; and
obtain the first usage data based on the received command.

11. The computer system of claim 10, wherein the program instructions further cause the processor set to:
extract a set of keywords from the received command;
apply an Artificial intelligence (AI) model on the extracted set of keywords; and
determine an objective of the received command based on the application of the AI model.

12. The computer system of claim 9, wherein the program instructions further cause the processor set to:
obtain second usage data associated with the at least one container based on the generation of the first allocation command, wherein the second usage data is obtained within a defined time period from an instance when the first usage data is obtained;
compare the obtained second usage data with the obtained set of threshold parameters;
detect a second anomaly associated with the usage of the one or more compute resources by the at least one container, wherein the second anomaly is detected based on the comparison of the obtained second usage data with the obtained set of threshold parameters;
determine a second set of allocation parameters associated with the at least one container based on the obtained second usage data, the obtained first usage data, and the detected second anomaly; and
generate a second allocation command based on the determined second set of allocation parameters, wherein the second allocation command is generated to reallocate the one or more compute resources to the at least one container.

13. The computer system of claim 9, wherein the determined first set of allocation parameters correspond to quantitative values which indicate resource allocation metrics of the one or more compute resources.

14. The computer system of claim 9, wherein the obtained first usage data comprises at least one of system-level resource usage data, container-level resource usage data, or container status data.

15. The computer system of claim 9, wherein the one or more compute resources comprise at least one of a Central Processing Unit (CPU) of a computing environment, a memory of the computing environment, one or more network resources of the computing environment, or one or more Input/Output (I/O) components of the computing environment, and wherein the computing environment runs the at least one container.

16. A computer program product for managing one or more compute resources for at least one container, the computer program product comprising:
one or more computer-readable storage media; and
program instructions stored on the one or more computer-readable storage media to perform operations comprising:
obtaining first usage data associated with the at least one container, wherein the obtained first usage data indicates a usage level of each compute resource of the one or more compute resources by the at least one container;
obtaining a set of threshold parameters associated with the at least one container, wherein the set of threshold parameters is obtained based on the obtained first usage data, and wherein the set of threshold parameters corresponds to acceptable usage level of each compute resource of the one or more compute resources by the at least one container;
comparing the obtained first usage data with the obtained set of threshold parameters;
detecting a first anomaly associated with a usage of the one or more compute resources by the at least one container, wherein the first anomaly is detected based on the comparison of the obtained first usage data with the obtained set of threshold parameters;
determining a first set of allocation parameters associated with the at least one container based on the obtained first usage data and the detected first anomaly; and
generating a first allocation command based on the determined first set of allocation parameters, wherein the first allocation command is generated to allocate the one or more compute resources to the at least one container.

17. The computer program product of claim 16, wherein the program instructions stored on the one or more computer-readable storage media perform the operations further comprising:
allocating the one or more compute resources to the at least one container to resolve the first anomaly, wherein the one or more compute resources are allocated based on the generated first allocation command.

18. The computer program product of claim 16, wherein the program instructions stored on the one or more computer-readable storage media perform the operations further comprising:
receiving a command to run the at least one container; and
obtaining the first usage data based on the received command.

19. The computer program product of claim 18, wherein the program instructions stored on the one or more computer-readable storage media perform the operations further comprising:
extracting a set of keywords from the received command;
applying an Artificial intelligence (AI) model on the extracted set of keywords; and
determining an objective of the received command based on the application of the AI model.

20. The computer program product of claim 16, wherein the program instructions stored on the one or more computer-readable storage media perform the operations further comprising:
obtaining second usage data associated with the at least one container based on the generation of the first allocation command, wherein the second usage data is obtained within a defined time period subsequent to the obtaining of the first usage data;
comparing the obtained second usage data with the obtained set of threshold parameters;
detecting a second anomaly associated with the usage of the one or more compute resources by the at least one container, wherein the second anomaly is detected based on the comparison of the obtained second usage data with the obtained set of threshold parameters;
determining a second set of allocation parameters associated with the at least one container based on the obtained second usage data, the obtained first usage data, and the detected second anomaly; and
generating a second allocation command based on the determined second set of allocation parameters, wherein the second allocation command is generated to reallocate the one or more compute resources to the at least one container.
